(19) United States
(12) Patent Application Publication
(10) Pub. No.: US 2025/0045841 A1
(43) Pub. Date: Feb. 6, 2025

(54) MUSIC REVENUE DISTRIBUTION APPARATUS AND NON-TRANSITORY COMPUTER-READABLE RECORDING MEDIUM STORING MUSIC REVENUE DISTRIBUTION PROGRAM

(71) Applicant: JVCKENWOOD Corporation, Yokohama-shi (JP)

(72) Inventor: Mizuki OHARA, Yokohama-shi (JP)

(21) Appl. No.: 18/769,483

(22) Filed: Jul. 11, 2024

(30) Foreign Application Priority Data
Aug. 2, 2023 (JP) 2023-126111

(51) Int. Cl. G06Q 40/12

(52) U.S. Cl. CPC G06Q 40/12

(57) ABSTRACT

A music revenue distribution apparatus includes a similarity calculator and a distribution rate determiner. The similarity calculator calculates a similarity between a completed piece of music including a target track to which a revenue is distributed for its creator and a comparative piece of music not including the target track in the completed piece of music. The distribution rate determiner determines a distribution rate that is a rate of revenue distribution for the creator of the target track with respect to a revenue generated from the completed piece of music based on the similarity.

### CROSS REFERENCE TO RELATED APPLICATION

This application claims the benefit of priority from the prior Japanese Patent Application No. 2023-126111, filed on Aug. 2, 2023, the entire contents of which are incorporated herein by reference.

### BACKGROUND

### 1. Field of the Invention

The present disclosure relates to a music revenue distribution technology.

### 2. Description of the Related Art

In music production, one completed piece of music is typically produced by overwriting with a plurality of tracks. The revenue generated from the completed piece of music created in this way may be distributed to the creator of each track. The distribution rate of the revenue for the creator of each track is determined by negotiation or the like with the creator or a party other than the creator, but there is no clear standard as to how to determine the distribution rate, and it is difficult to distribute the revenue appropriately. In particular, in recent years, persons who are not directly familiar with each other can be creators of a plurality of tracks included in one completed piece of music via the Internet or the like, and it is required to reasonably distribute the revenue.

Patent Literature 1 describes that when two or more participants participate in content creation together, the degree of contribution of these participants (for example, a scriber, a composer, or the like) is quantified, and the revenue is distributed according to the degree of contribution.
Patent Literature 1: JP 2015-521330 A

Patent Literature 1 describes that the degree of contribution of each cooperating worker is analyzed based on the amount of composition of each cooperating worker in the composition content. However, the amount of composition does not necessarily indicate contribution to the completed piece of music, and there is room for improvement.

### SUMMARY

A music revenue distribution apparatus according to an embodiment includes a similarity calculator configured to calculate a similarity between a completed piece of music including a target track to which a revenue is distributed for its creator and a comparative piece of music not including the target track in the completed piece of music, and a distribution rate determiner configured to determine a distribution rate that is a rate of the revenue distribution for the creator of the target track with respect to a revenue generated from the completed piece of music based on the similarity.

Another embodiment is a non-transitory computer-readable recording medium storing a music revenue distribution program. This program comprises computer-implemented modules that include a module that calculates a similarity between a completed piece of music including a target track to which a revenue is distributed for its creator and a comparative piece of music that does not include the target track in the completed piece of music, and a module that determines a distribution rate that is a rate of revenue distribution for the creator of the target track with respect to a revenue generated from the completed piece of music based on the similarity.

Any combinations of the above-described components and expressions of the present disclosure converted between methods, apparatuses, systems, recording media, computer programs, and the like are also effective as aspects of the present disclosure.

### BRIEF DESCRIPTION OF THE DRAWINGS

Embodiments will now be described, by way of example only, with reference to the accompanying drawings that are meant to be exemplary, not limiting, and wherein like elements are numbered alike in several figures, in which:

FIG. 1 is a block diagram schematically illustrating a schematic configuration of a music revenue distribution apparatus according to a present embodiment;

FIG. 2 is a conceptual diagram illustrating an example of a flow of music generation using the music revenue distribution apparatus of FIG. 1;

FIG. 3 is a conceptual diagram illustrating an example of a data configuration of a completed piece of music and a comparative piece of music;

FIG. 4 is a diagram illustrating an example of evaluation values at a plurality of timings in a play time of a completed piece of music and each track included in the completed piece of music;

FIG. 5 is a diagram illustrating an example of the similarity between a completed piece of music and a comparative piece of music calculated by the similarity calculator in FIG. 1; and

FIG. 6 is a flowchart illustrating an example of a procedure of music revenue distribution processing with the music revenue distribution apparatus of FIG. 1.

### DETAILED DESCRIPTION

The invention will now be described by reference to the preferred embodiments. This does not intend to limit the scope of the present invention, but to exemplify the invention.

Hereinafter, embodiments of the present disclosure will be described with reference to the drawings. Specific numerical values and the like shown in such embodiments are merely examples for facilitating understanding of the invention, and do not limit the present disclosure unless otherwise specified. In the drawings, illustration of elements not directly related to the present disclosure is omitted.

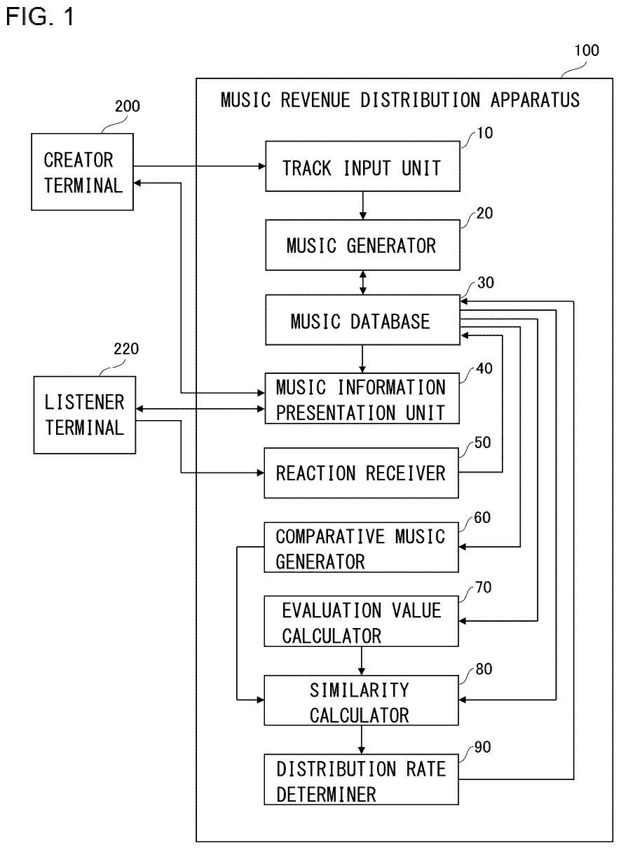

FIG. 1 is a block diagram schematically illustrating a schematic configuration of a music revenue distribution apparatus 100 according to a present embodiment. As illustrated in FIG. 1, a creator terminal 200 and a listener terminal 220 are connected to the music revenue distribution apparatus 100 via a network. FIG. 1 illustrates one creator terminal 200 and one listener terminal 220, but a plurality of creator terminals 200 and a plurality of listener terminals 220 may be connected to the music revenue distribution apparatus 100. The music revenue distribution apparatus 100 includes a network interface and transmits and receives various types of information to and from the creator terminal 200 and the listener terminal 220 via the network interface. Description of the details of the network interface will be omitted.

The creator terminal 200 is a terminal operated by a user (hereinafter, referred to as “creator”) who creates a track included in a piece of music. The creator terminal 200 transmits the track to the music revenue distribution apparatus 100 according to the operation of the creator. The listener terminal 220 is a terminal operated by a user (hereinafter, referred to as “listener”) who listens to the piece of music. The listener terminal 220 receives the piece of music from the music revenue distribution apparatus 100 and plays the received music according to the operation of the listener. A single terminal may function as the creator terminal 200 and the listener terminal 220. For example, in a case where a creator of a track is a creator and a listener of a piece of music at the same time, a single terminal can be used as the creator terminal 200 and the listener terminal 220.

The music revenue distribution apparatus 100 includes a track input unit 10, a music generator 20, a music database 30, a music information presentation unit 40, a reaction receiver 50, a comparative music generator 60, an evaluation value calculator 70, a similarity calculator 80, and a distribution rate determiner 90.

Each functional block shown in the present embodiment can be realized, for example, by cooperation of hardware and software. The hardware of each of the music revenue distribution apparatus 100, the creator terminal 200, and the listener terminal 220 is realized by an element including a processor such as a central processing unit (CPU) or a graphics processing unit (GPU) of a computer and a memory such as a read only memory (ROM) or a random access memory (RAM), or a mechanical device. The software of each of the music revenue distribution apparatus 100, the creator terminal 200, and the listener terminal 220 is realized by a computer program or the like. These pieces of software can be provided by being recorded in a non-transitory recording medium readable by a computer or the like, can be transmitted and received to and from a server through a wired or wireless network, and can be transmitted and received as data broadcasting of terrestrial or satellite digital broadcasting.

The track input unit 10 receives an input of a track transmitted from the creator terminal 200. The track input by the track input unit 10 may be an audio track including audio waveform information, or may be a musical instrument digital interface (MIDI) track including MIDI data and MIDI sound source information. When the track input unit 10 receives inputs of a plurality of tracks, the plurality of tracks may include a mixture of an audio track and a MIDI track. The track received by the track input unit 10 includes a track for a new piece of music and a track for addition to an existing piece of music.

The music generator 20 generates a piece of music including one or more tracks input from the track input unit 10. The music generator 20 stores the generated piece of music in the music database 30. When the piece of music generated by the music generator 20 includes a plurality of tracks, the plurality of tracks may overlap each other on the same time axis to configure the piece of music. When a track for a new piece of music is input via the track input unit 10, the music generator 20 sets the track for the new piece of music as a new piece of music and stores the new piece of music in the music database 30. When a track for addition to an existing piece of music is input via the track input unit 10, the music generator 20 reads the existing piece of music specified in the track from the music database 30, generates a piece of music in which the input track is added to the existing piece of music, and stores the generated piece of music in the music database 30. When one piece of music generated by the music generator 20 includes a plurality of tracks, the plurality of tracks may include a mixture of an audio track and a MIDI track.

The music revenue distribution apparatus 100 sets a piece of music satisfying a predetermined condition as a completed piece of music. The predetermined condition for setting the piece of music as the completed piece of music is not particularly limited, and the condition can be, for example, that the number of tracks included in the music reaches a predetermined number, that a determination operation of music completion is input from the creator terminal 200, or the like. The completed piece of music is released, and a revenue may be produced from the completed piece of music. Hereinafter, a piece of music other than the completed piece of music is also referred to as an uncompleted piece of music. When the music is simply referred to as a piece of music, the completed piece of music and the uncompleted piece of music are not particularly distinguished.

The music database 30 stores one or more pieces of music generated by the music generator 20. The music database 30 stores related information (hereinafter, referred to as “music related information”) of each piece of music in association with each piece of music. The music related information includes, for example, a creator name of a track included in the piece of music, a title of the music, a duration of the music, and a generation date and time of the music. The music related information may include reaction information to be described later. The piece of music and the music related information are not limited to being centrally managed in the database, and may be managed on a blockchain in a distributed manner as a non-fungible token (NFT). The NFT functions as digital data with a certificate of possession of the piece of music.

The music information presentation unit 40 presents one or more pieces of music stored in the music database 30 and music related information (hereinafter, these are also collectively referred to as “music information”) corresponding to the piece of music to the creator terminal 200 and the listener terminal 220. Specifically, the music information presentation unit 40 displays at least a part of the music related information for each piece of music, for example, the creator name of a track or the title of the piece of music on the creator terminal 200 and the listener terminal 220. When receiving a music play instruction from the creator terminal 200 or the listener terminal 220, the music information presentation unit 40 transmits the piece of music and causes the creator terminal 200 or the listener terminal 220 to which the play instruction has been transmitted to play the piece of music. When receiving an input of the track for addition to a designated existing piece of music from the creator terminal 200 via the track input unit 10, the music information presentation unit 40 displays the music related information of the piece of music in which the input track has been added to the existing piece of music on the creator terminal 200 and the listener terminal 220.

The reaction receiver 50 receives an input of reaction information to the piece of music transmitted from the listener terminal 220. The reaction information is information regarding a reaction of the listener to the piece of music, and the information may be, for example, an operation indicating an intention such as a so-called “like” button operation, posting of a comment, the number of times of play of the piece of music, or the like. The reaction information may include a positive reaction, a negative reaction, and a neutral reaction. For example, a “like” button operation or the number of times of play of the piece of music may be a positive reaction. For example, the reaction receiver 50 may determine a positive reaction, a negative reaction, or a neutral reaction through text analysis of the posted comment. The reaction receiver 50 may use biological information such as a pulse rate and brain waves of the listener of the piece of music transmitted from the listener terminal 220 as the reaction information.

The reaction receiver 50 stores the received reaction information in the music database 30 in association with the piece of music. The reaction receiver 50 may associate the reaction information with a timing of the duration of the piece of music. For example, when the received reaction information is the reaction information at a specific timing in the duration of the piece of music being played, the reaction receiver 50 may associate the reaction information with the timing, and can treat the information as information of the reaction of the listener to the performance content at the timing of the piece of music.

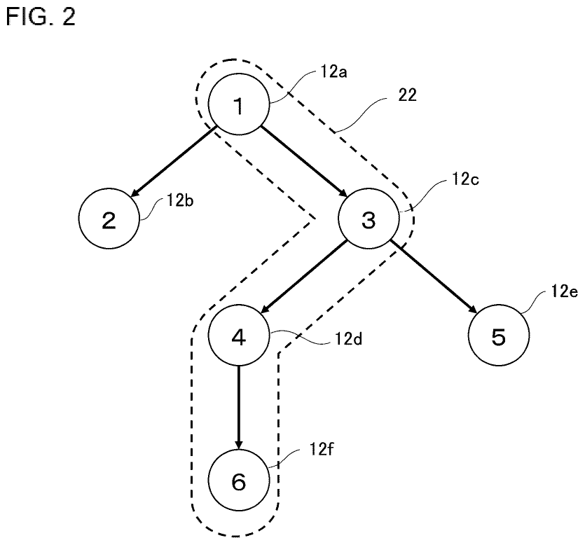

FIG. 2 is a conceptual diagram illustrating an example of a flow of music generation using the music revenue distribution apparatus 100. First, a creator A inputs a first track 12a played on the guitar as a track for a new piece of music via the track input unit 10. The music generator 20 stores the first track 12a as a new piece of music in the music database 30. The music information presentation unit 40 presents the information of the piece of music formed of the first track 12a stored in the music database 30 to the creator terminal 200 and the listener terminal 220.

Thereafter, a creator B inputs a second track 12b played on the piano as a track for addition to the piece of music formed of the first track 12a via the track input unit 10. The music generator 20 generates a piece of music in which the second track 12b is added to the piece of music formed of the first track 12a, and stores the generated piece of music in the music database 30. The music information presentation unit 40 further presents the information of the piece of music formed of the first track 12a and the second track 12b stored in the music database 30 to the creator terminal 200. For example, as illustrated in FIG. 2, the music information presentation unit 40 outputs the information of the piece of music formed of the first track 12a and the second track 12b as display information in which an image of the first track 12a and an image of the second track 12b are connected by an arrow, and the same applies to the other pieces of music. When a creator C inputs a third track 12c played on the drum as a track for addition to the piece of music formed of the first track 12a, the music generator 20 generates a piece of music in which the third track 12c is added to the piece of music formed of the first track 12a, and stores the generated piece of music in the music database 30. The music information presentation unit 40 further presents the information of the piece of music formed of the first track 12a and the third track 12c stored in the music database 30 to the creator terminal 200.

Thereafter, a creator D inputs a fourth track 12d played on the bass guitar as a track for addition to the piece of music formed of the first track 12a and the third track 12c. The music information presentation unit 40 further presents information of the piece of music formed of the first track 12a, the third track 12c, and the fourth track 12d to the creator terminal 200. A creator E inputs a fifth track 12e played on the saxophone as a track for addition to the piece of music formed of the first track 12a and the third track 12c. The music information presentation unit 40 further presents information of the piece of music formed of the first track 12a, the third track 12c, and the fifth track 12e to the creator terminal 200.

Thereafter, a creator F inputs a sixth track 12f played on the piano as a track for addition to the piece of music formed of the first track 12a, the third track 12c, and the fourth track 12d. At this time, the music revenue distribution apparatus 100 determines that the piece of music formed of the first track 12a, the third track 12c, the fourth track 12d, and the sixth track 12f satisfies the predetermined condition, and releases the piece of music as a completed piece of music 22. The music information presentation unit 40 may further present the information of the completed piece of music 22 to the creator terminal 200 and the listener terminal 220.

The revenue generated from the released completed piece of music 22 is distributed to the creator of each track included in the completed piece of music 22 according to the distribution rate determined by the distribution rate determiner 90 to be described later. In the description of the present embodiment, distributing the revenue generated from the completed piece of music 22 to the creator of each track included in the completed piece of music 22 is referred to as revenue distribution. The rate of the revenue distributed to the creator of each track to the revenue generated from the completed piece of music 22 is referred to as a revenue distribution rate or simply a distribution rate. The music information presented by the music information presentation unit 40 described above may be display information that displays contents similar to those in the conceptual diagram illustrated in FIG. 2.

Returning to FIG. 1, the reaction receiver 50 may receive reaction information for the piece of music presented from the music information presentation unit 40 from the listener terminal 220. The reaction information from the listener terminal 220 may be for the completed piece of music 22 or an uncompleted piece of music. In addition, for example, after the completed piece of music 22 is generated, the music information presentation unit 40 may play, from the listener terminal 220, the piece of music in which any one or more tracks of the first track 12a, the third track 12c, the fourth track 12d, and the sixth track 12f included in the completed piece of music 22 are excluded. The reaction information for the piece of music in which one or more freely-selected tracks are excluded from the completed piece of music 22 may be received from the listener terminal 220 via the reaction receiver 50. Such reaction information is reaction information for a comparative piece of music in which a freely-selected target track is excluded from the completed piece of music 22. Details of the comparative piece of music will be described later.

The comparative music generator 60 generates the data of the comparative piece of music by excluding the data of the target track to which the revenue is distributed for the creator from the data of the completed piece of music 22 stored in the music database 30. In other words, the comparative piece of music is a piece of music not including the target track in the completed piece of music 22. The comparative music generator 60 generates data of a comparative piece of music for each of all tracks included in the completed piece of music 22.

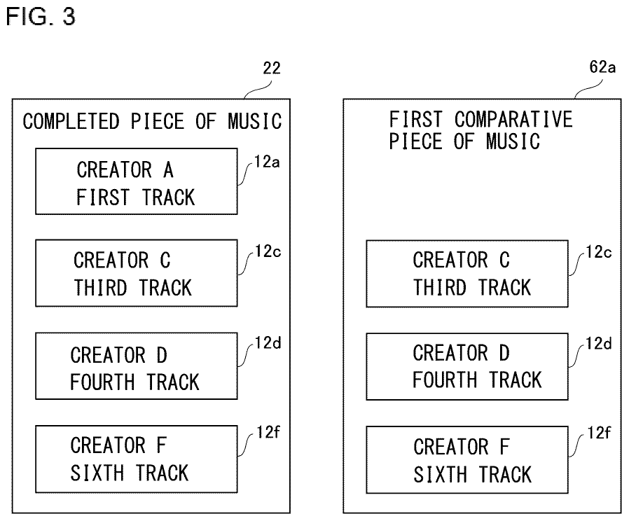

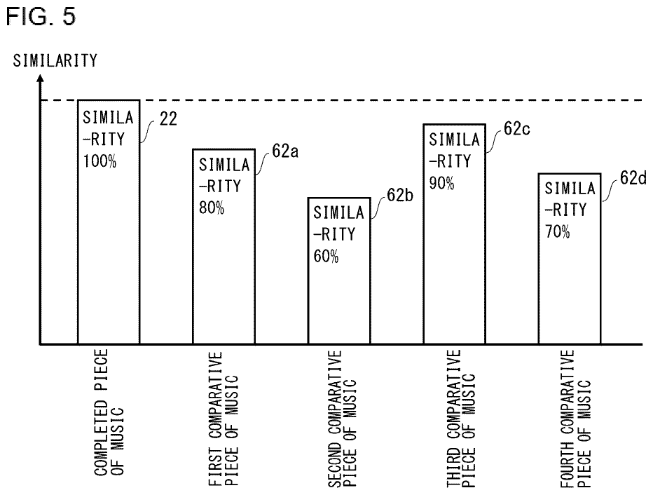

FIG. 3 is a conceptual diagram illustrating an example of a data configuration of the completed piece of music 22 and a comparative piece of music (here, a first comparative piece of music 62a is exemplified). As illustrated in FIG. 2, the completed piece of music 22 includes the first track 12a created by the creator A, the third track 12c created by the creator C, the fourth track 12d created by the creator D, and the sixth track 12f created by the creator F. The first comparative piece of music 62a is a piece of music generated by excluding the first track 12a as the target track from the completed piece of music 22. That is, the first comparative piece of music 62a includes the third track 12c created by the creator C, the fourth track 12d created by the creator D, and the sixth track 12f created by the creator F, and does not include the first track 12a created by the creator A. The comparative music generator 60 generates, in the same manner as for the first comparative piece of music 62a, the data of a second comparative piece of music 62b (see FIG. 5) whose target track is the third track 12c, the data of a third comparative piece of music 62c (see FIG. 5) whose target track is the fourth track 12d, and the data of a fourth comparative piece of music 62d (see FIG. 5) whose target track is the sixth track 12f from the data of the completed piece of music 22. Hereinafter, when the first comparative piece of music 62a to the fourth comparative piece of music 62d are not particularly distinguished, they are also collectively referred to as comparative piece of music 62.

Returning to FIG. 1, the evaluation value calculator 70 calculates an overall evaluation value that is an evaluation value of the completed piece of music 22 evaluated by the listener and a partial evaluation value that is an evaluation value of the comparative piece of music 62 evaluated by the listener. The evaluation value calculator 70 aggregates reaction information for the completed piece of music 22 input via the reaction receiver 50 and stored in the music database 30 and calculates the evaluation values. The evaluation value calculator 70 calculates the evaluation values by aggregating the reaction information for the comparative piece of music 62 input via the reaction receiver 50 and stored in the music database 30. For example, the evaluation value calculator 70 may add points to the evaluation values when the reaction information is a positive reaction, or may subtract points from the evaluation value when the reaction information is a negative reaction.

The evaluation value calculator 70 may aggregate the reaction information associated with a plurality of timings in the duration of the piece of music, and calculate the overall evaluation value and the partial evaluation value for the plurality of timings in the duration of the completed piece of music 22 and the comparative piece of music 62.

The similarity calculator 80 calculates similarity between the completed piece of music 22 and the comparative piece of music 62. Specifically, the similarity calculator 80 may compare the data of the completed piece of music 22 with the data of the comparative piece of music 62, and calculate the similarity based on the comparison result, may calculate the similarity based on the overall evaluation value and the partial evaluation value calculated by the evaluation value calculator 70, or may calculate the similarity based on both of them.

First, a case where the similarity calculator 80 compares the data of the completed piece of music 22 with the data of the comparative piece of music 62 and calculates the similarity based on the comparison result will be described. As a method of comparing music data used by the similarity calculator 80, various methods used for similarity comparison of music data and audio data can be adopted. For example, the similarity calculator 80 may divide the music data into frames, extract and compare the feature amount of each frame, and calculate the similarity. For example, the similarity calculator 80 may perform Fourier transform on the music data to convert the music data into a spectral representation, and may compare the shapes and features of the spectra to calculate the similarity. For example, the similarity calculator 80 may perform wavelet transform on the music data to extract time and frequency information, and calculate the similarity. The similarity calculator 80 may learn the similarity from the feature amount of the music data using a machine learning algorithm such as deep learning. The similarity calculator 80 may use a statistical value such as a correlation value as the similarity.

Next, a case where the similarity calculator 80 calculates the similarity based on the overall evaluation value and the partial evaluation value calculated by the evaluation value calculator 70 will be described. The similarity calculator 80 calculates the similarity from a difference or a ratio between the overall evaluation value that is the evaluation value of the completed piece of music 22 and the partial evaluation value that is the evaluation value of the comparative piece of music 62. The similarity calculator 80 may calculate the similarity based on a correlation between the overall evaluation value and the partial evaluation value calculated for a plurality of timings in the duration of the piece of music.

Here, an example of the similarity calculated by the similarity calculator 80 will be described with reference to FIG. 2. The similarity calculator 80 calculates the similarity between the overall evaluation value of the completed piece of music 22 and the partial evaluation value of the first comparative piece of music 62a in which the first track 12a is excluded from the completed piece of music 22. In the same manner, the similarity calculator 80 calculates the similarity between the overall evaluation value and the partial evaluation value of the second comparative piece of music 62b in which the third track 12c is excluded from the completed piece of music 22, the similarity between the overall evaluation value and the partial evaluation value of the third comparative piece of music 62c in which the fourth track 12d is excluded from the completed piece of music 22, and the similarity between the overall evaluation value and the partial evaluation value of the fourth comparative piece of music 62d in which the sixth track 12f is excluded from the completed piece of music 22.

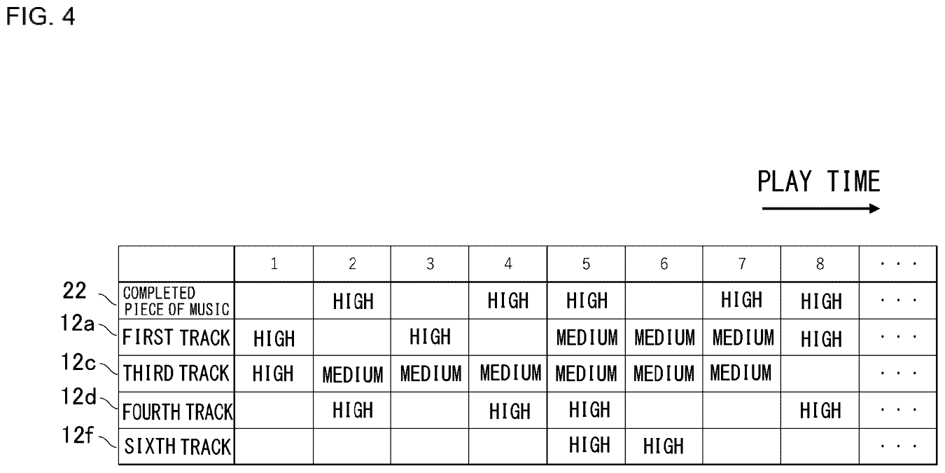

FIG. 4 is a diagram illustrating an example of evaluation values at a plurality of timings in a play time of the completed piece of music 22 and each track included in the completed piece of music 22. In FIG. 4, the horizontal direction indicates the play time, and the play time elapses as it goes rightward direction. A plurality of timings of the play time are indicated by “1”, “2”, . . . , and “8”. In the completed piece of music 22 and the first track 12a to the sixth track 12f, a timing when the evaluation value is high is indicated by “HIGH”, a timing when the evaluation value is medium is indicated by “MEDIUM”, and a timing when the evaluation value is low is indicated by blanks. The plurality of timings of the play time may be divided by the play time or may be divided by each section (intro, melody A, melody B, chorus, and the like) of the piece of music.

From the evaluation values at a plurality of timings as illustrated in FIG. 4, the correlation between the overall evaluation value of the completed piece of music 22 and the evaluation value of each track can be read. For example, the completed piece of music 22 takes a high evaluation value at the plurality of timings “2”, “4”, “5”, “7”, and “8”, and the fourth track 12d shows the tendency closest to this. In this case, since the third comparative piece of music 62c whose target track is the fourth track 12d is a piece of music formed of the first track 12a, the third track 12c, and the sixth track 12f in which the fourth track 12d is excluded from the completed piece of music 22, the third comparative piece of music 62c is calculated to have a lower similarity to the completed piece of music 22 than the other comparative pieces of music.

Next, a case where the similarity calculator 80 calculates the similarity based on the comparison result between the data of the completed piece of music 22 and the data of the comparative piece of music 62 and both the overall evaluation value and the partial evaluation value will be described. The similarity calculator 80 may calculate the final similarity based on the similarity calculated based on the comparison result between the data of the completed piece of music 22 and the data of the comparative piece of music 62 and the similarity calculated based on the overall evaluation value and the partial evaluation value, for example, by averaging these. The similarity calculator 80 may adjust the similarity calculated based on the comparison result between the data of the completed piece of music 22 and the data of the comparative piece of music 62 based on the overall evaluation value and the partial evaluation value. The similarity calculator 80 may calculate the contribution degree of each comparative piece of music 62 to the completed piece of music 22 at each of a plurality of timings of the duration based on the comparison result between the data of the completed piece of music 62 and the data of the comparative piece of music 22. Then, the similarity calculator 80 may calculate the similarity such that the similarity becomes lower in the comparative piece of music 62 in which the track having a higher contribution degree is excluded at the timing when the overall evaluation value in the duration is relatively high. For example, at the timing when the piano is played alone in intro, the degree of contribution of the piano track is calculated to be high, that is, the degree of contribution of the comparative piece of music 62 excluding the piano track is calculated to be low. Thus, when the overall evaluation value is high at the timing, it is considered that the piano track is highly evaluated, and the similarity calculator 80 calculates the similarity of the comparative piece of music 62 excluding the piano track to be relatively low.

Returning to FIG. 1, the distribution rate determiner 90 determines the distribution rate of the revenue generated from the completed piece of music 22 for the creator of the target track based on the similarity calculated by the similarity calculator 80. Here, as described above, the similarity calculated by the similarity calculator 80 is the similarity between the completed piece of music 22 and the comparative piece of music 62, and the data of the comparative piece of music 62 is generated by excluding the data of the target track from the data of the completed piece of music 22. Thus, the lower the similarity, the larger the degree of difference of the piece of music in which the target track is excluded from the completed piece of music 22, that is, the larger the degree of influence of the target track in the completed piece of music 22. In the same manner, the higher the similarity, the smaller the degree of influence of the target track in the completed piece of music 22. Thus, the distribution rate determiner 90 increases the distribution rate for the creator of the target track as the similarity is lower. As a result, the distribution rate of the revenue generated from the completed piece of music 22 becomes larger for the creator of the track having a larger influence degree on the completed piece of music 22, and thus the revenue can be distributed according to the contribution degree to the completed piece of music 22. The distribution rate determiner 90 may store the determined distribution rate in the music database 30 in association with the completed piece of music 22.

FIG. 5 is a diagram illustrating an example of similarity between the completed piece of music 22 and the comparative piece of music 62 calculated by the similarity calculator 80. FIG. 5 illustrates the similarity of each of the first comparative piece of music 62a to the fourth comparative piece of music 62d to the completed piece of music 22 as a similarity rate by percentage. In the example illustrated in FIG. 5, the similarity rates with respect to the completed piece of music 22 is 100% for the completed piece of music 22, 80% for the first comparative piece of music 62a, 60% for the second comparative piece of music 62b, 90% for the third comparative piece of music 62c, and 70% for the fourth comparative piece of music 62d.

The distribution rate determiner 90 may calculate a change rate due to the exclusion of the target track from the completed piece of music 22 based on the similarity rate illustrated in FIG. 5. The change rate can be calculated by subtracting the similarity rate from 100%. For example, the change rate obtained by excluding the first track 12a from the completed piece of music 22 is 20% obtained by subtracting 80% that is the similarity rate of the first comparative piece of music 62a from 100%. In the same manner, the change rate due to the exclusion of the third track 12c from the completed piece of music 22 is 40% obtained by subtracting 60% that is the similarity rate of the second comparative piece of music 62b from 100%. The change rate obtained by excluding the fourth track 12d from the completed piece of music 22 is 10% obtained by subtracting 90% that is the similarity rate of the third comparative piece of music 62c from 100%. The change rate obtained by excluding the sixth track 12f from the completed piece of music 22 is 30% obtained by subtracting 70% that is the similarity rate of the fourth comparative piece of music 62d from 100%.

The distribution rate determiner 90 may set the change rate due to the exclusion of each target track as the distribution rate for the creator of each track. In this case, the distribution rate for the creator A of the first track 12a is 20%, the distribution rate for the creator C of the third track 12c is 40%, the distribution rate for the creator D of the fourth track 12d is 10%, and the distribution rate for the creator F of the sixth track 12f is 30%. Thus, for example, when the revenue from the completed piece of music 22 is 100,000 yen, the revenue for the creator A is 20,000 yen, the revenue for the creator C is 40, 000 yen, the revenue for the creator D is 10,000 yen, and the revenue for the creator F is 30,000 yen.

The music revenue distribution apparatus 100 does not need to distribute all of the revenue to the creator of each track according to the distribution rate, and for example, it may equally distribute a part of the revenue and distribute the rest according to the distribution rate. For example, the music revenue distribution apparatus 100 equally distributes 40,000 yen out of the revenue of 100,000 yen of the completed piece of music 22 and distributes the rest according to the distribution rate. In this case, the revenue for the creator A is 40,000 yen/4+60,000 yen x 0.2=22,000 yen, the revenue for the creator C is 40,000 yen/4+60,000 yen x 0.4=34,000 yen, the revenue for the creator D is 40,000 yen/4+60,000 yen x 0.1=16,000 yen, and the revenue for the creator F is 40,000 yen/4+60,000 yen x 0.3=28,000 yen.

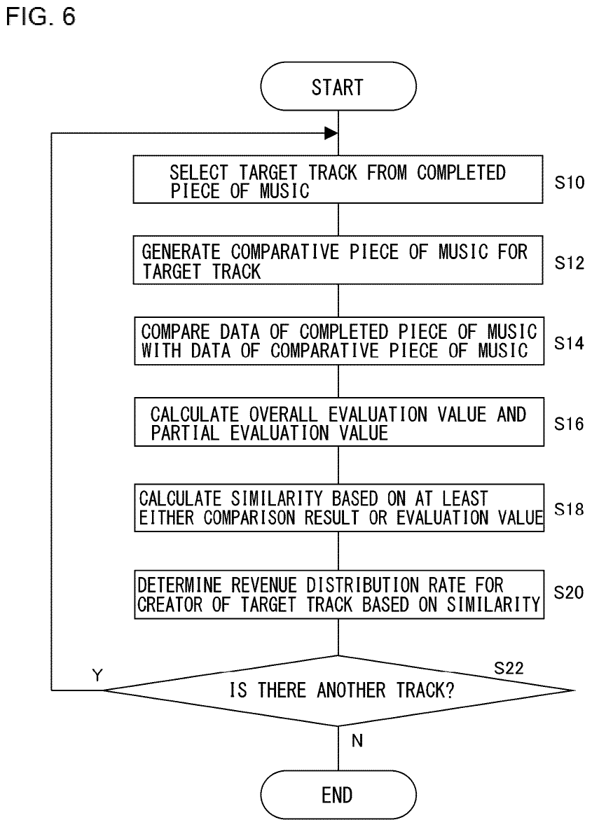

FIG. 6 is a flowchart illustrating an example of a procedure of music revenue distribution processing with the music revenue distribution apparatus 100. The processing illustrated in FIG. 6 is based on the premise that the completed piece of music 22 generated by the music generator 20 is stored in the music database 30 in advance. The processing illustrated in FIG. 6 is music revenue distribution processing for one completed piece of music 22.

The comparative music generator 60 selects a target track to which the revenue is distributed for the creator from the tracks included in the completed piece of music 22 (S10). The comparative music generator 60 generates the comparative piece of music 62 for the target track by excluding the data of the target track from the data of the completed piece of music 22 (S12).

The similarity calculator 80 compares the data of the completed piece of music 22 with the data of the comparative piece of music 62 (S14). The evaluation value calculator 70 calculates an overall evaluation value that is an evaluation value of the completed piece of music 22 evaluated by the listener and a partial evaluation value that is an evaluation value of the comparative piece of music 62 evaluated by the listener (S16). The order of step S14 and step S16 may be reversed. The similarity calculator 80 calculates the similarity between the completed piece of music 22 and the comparative piece of music 62 based on at least either the comparison result in step S14 or the overall evaluation value and the partial evaluation value calculated in step S16 (S18).

The distribution rate determiner 90 determines the revenue distribution rate for the creator of the target track based on the similarity calculated in S18 (S20). When there is a track that is not selected as the target track among the tracks included in the completed piece of music 22 (Y in S22), the music revenue distribution apparatus 100 returns to step S10. When all the tracks included in the completed piece of music 22 have been selected as the target tracks (N in S22), the music revenue distribution apparatus 100 ends the processing.

As described above, the music revenue distribution apparatus 100 according to the present embodiment includes the similarity calculator 80 that calculates the similarity between the completed piece of music 22 including the target track to which the revenue is distributed for the creator and the comparative piece of music 62 not including the target track in the completed piece of music 22, and the distribution rate determiner 90 that determines the distribution rate of the revenue from the completed piece of music 22 for the creator of the target track based on the similarity. The distribution rate determiner 90 increases the distribution rate for the creator as the similarity is lower. Thus, since the music revenue distribution apparatus 100 determines the distribution rate of the revenue for the creator of the target track based on the result of objectively evaluating the influence when the target track is not included in the completed piece of music 22, the revenue from the completed piece of music 22 can be appropriately distributed.

In addition, the music revenue distribution apparatus 100 according to the present embodiment further includes the comparative music generator 60 that generates the data of the comparative piece of music 62 by excluding the data of the target track from the data of the completed piece of music 22, and the similarity calculator 80 compares the data of the completed piece of music 22 with the data of the comparative piece of music 62 and calculates the similarity based on the comparison result. Thus, the music revenue distribution apparatus 100 can determine the distribution rate of the revenue for the creator of the target track based on a more objective evaluation result based on the data analysis of the piece of music.

Further, the music revenue distribution apparatus 100 according to the present embodiment further includes the evaluation value calculator 70 that calculates an overall evaluation value that is an evaluation value evaluated by the listener for the completed piece of music 22 and a partial evaluation value that is an evaluation value evaluated by the listener for the comparative piece of music 62, and the similarity calculator 80 calculates the similarity based on the overall evaluation value and the partial evaluation value. Thus, the music revenue distribution apparatus 100 can calculate the similarity based on the evaluation of the listener which has a higher relationship with the revenue.

Further, in the music revenue distribution apparatus 100 according to the present embodiment, the evaluation value calculator 70 calculates the overall evaluation value and the partial evaluation value for each of a plurality of timings in the duration of the completed piece of music 22 and the comparative piece of music 62, and the similarity calculator 80 calculates the similarity based on the correlation between the overall evaluation value and the partial evaluation value at the plurality of timings. Thus, the music revenue distribution apparatus 100, using the information of the evaluation of the listener for each timing in the duration of the piece of music for the calculation of the similarity, can calculate the similarity with higher accuracy.

The present disclosure has been described above based on an embodiment. It is to be understood by those skilled in the art that the embodiment is an example, various modifications can be made to the combination of each component and each processing process, and such modifications are also within the scope of the present disclosure.

For example, in the present embodiment, it has been described that the music revenue distribution apparatus 100 generates the completed piece of music 22 including a plurality of tracks input from the track input unit 10. However, the completed piece of music 22 is not limited to a piece of music generated by the music revenue distribution apparatus 100, and it may be input to the music revenue distribution apparatus 100 from the outside. Further, the plurality of tracks included in the completed piece of music 22 does not have to be separable as data but may be configured to be separable into a plurality of tracks by analyzing the completed piece of music 22 by voice recognition or the like, for example. When the completed piece of music 22 is input from the outside, the input completed piece of music 22 is stored in the music database 30, for example. In this case, the music revenue distribution apparatus 100 does not have to include the track input unit 10 and the music generator 20.

The number of creators of each of the plurality of tracks included in the music revenue distribution apparatus 100 is not necessarily one for each track. For example, the number of players of one track may be plural, or the composer and the player may be different persons. When there are a plurality of creators for one track, the revenue for each track distributed according to the distribution rate determined by the distribution rate determiner 90 may be further distributed according to the agreement between the creators.

In the present embodiment, the description has been given assuming that the evaluation value calculator 70 calculates the overall evaluation value evaluated by the listener for the completed piece of music 22 and the partial evaluation value that is the evaluation value evaluated by the listener for the comparative piece of music 62, and the similarity calculator 80 calculates the similarity based on the overall evaluation value and the partial evaluation value. However, the evaluation value calculator 70 may directly calculate the evaluation value evaluated by the listener for the target track instead of the partial evaluation value, and the similarity calculator 80 may calculate the similarity based on the overall evaluation value and the evaluation value for the target track. In this case, the distribution rate determiner 90 may increase the distribution rate for the creator of the target track as the similarity is higher.

What is claimed is:

1. A music revenue distribution apparatus comprising:
a similarity calculator configured to calculate a similarity between a completed piece of music including a target track to which a revenue is distributed for its creator and a comparative piece of music not including the target track in the completed piece of music; and
a distribution rate determiner configured to determine a distribution rate that is a rate of the revenue distribution for the creator of the target track with respect to a revenue generated from the completed piece of music based on the similarity.

2. The music revenue distribution apparatus according to claim 1, wherein
the distribution rate determiner increases the distribution rate for the creator as the similarity is lower.

3. The music revenue distribution apparatus according to claim 1, the apparatus further comprising a comparative music generator configured to generate data of the comparative piece of music by excluding data of the target track from data of the completed piece of music, wherein the similarity calculator compares the data of the completed piece of music with the data of the comparative piece of music and calculates the similarity based on a comparison result.

4. The music revenue distribution apparatus according to claim 1, the apparatus further comprising an evaluation value calculator configured to calculate an overall evaluation value that is an evaluation value of the completed piece of music evaluated by a listener and a partial evaluation value that is an evaluation value of the comparative piece of music evaluated by the listener, wherein the similarity calculator calculates the similarity based on the overall evaluation value and the partial evaluation value.

5. The music revenue distribution apparatus according to claim 2, the apparatus further comprising an evaluation value calculator configured to calculate an overall evaluation value that is an evaluation value of the completed piece of music evaluated by a listener and a partial evaluation value that is an evaluation value of the comparative piece of music evaluated by the listener, wherein the similarity calculator calculates the similarity based on the overall evaluation value and the partial evaluation value.

6. The music revenue distribution apparatus according to claim 4, wherein
the evaluation value calculator calculates the overall evaluation value and the partial evaluation value for a plurality of timings in a duration of the completed piece of music and the comparative piece of music, and
the similarity calculator calculates the similarity based on a correlation between the overall evaluation value and the partial evaluation value at the plurality of timings.

7. The music revenue distribution apparatus according to claim 5, wherein
the evaluation value calculator calculates the overall evaluation value and the partial evaluation value for a plurality of timings in a duration of the completed piece of music and the comparative piece of music, and
the similarity calculator calculates the similarity based on a correlation between the overall evaluation value and the partial evaluation value at the plurality of timings.

8. A non-transitory computer-readable recording medium storing a music revenue distribution program comprising computer-implemented modules that include:
a module that calculates a similarity between a completed piece of music including a target track to which a revenue is distributed for its creator and a comparative piece of music that does not include the target track in the completed piece of music; and
a module that determines a distribution rate that is a rate of revenue distribution for the creator of the target track with respect to a revenue generated from the completed piece of music based on the similarity.
